(19) United States
(12) Patent Application Publication
(10) Pub. No.: US 2021/0114347 A1
(43) Pub. Date: Apr. 22, 2021

(54) ROLL-BONDED LAMINATE FOR ELECTRONIC DEVICE AND ELECTRONIC DEVICE HOUSING

(71) Applicant: TOYO KOHAN CO., LTD., Shinagawa-ku, Tokyo (JP)

(72) Inventors: Kota SADAKI, Yamaguchi (JP); Teppei KUROKAWA, Yamaguchi (JP); Yusuke HASHIMOTO, Yamaguchi (JP); Takafumi HATAKEDA, Yamaguchi (JP); Takashi KOSHIRO, Yamaguchi (JP)

(73) Assignee: TOYO KOHAN CO., LTD., Shinagawa-ku, Tokyo (JP)

(21) Appl. No.: 16/498,070

(22) PCT Filed: Mar. 29, 2018
(86) PCT No.: PCT/JP2018/013217

§ 371 Date: Sep. 26, 2019

(30) Foreign Application Priority Data
Mar. 29, 2017 (JP) 2017-066268
Jul. 31, 2017 (JP) 2017-148053
Dec. 22, 2017 (JP) 2017-246865

(51) Int. Cl. B32B 15/01; C23F 4/00; B23K 20/04; C22F 1/04

(52) U.S. Cl. CPC B32B 15/012; C23F 4/00; B23K 2103/04; C22F 1/04; B23K 20/04

(57) ABSTRACT

This invention provides a roll-bonded laminate for an electronic device that exhibits high rigidity and a high elastic modulus and is suitable for housing applications. More specifically, this invention concerns a roll-bonded laminate for an electronic device composed of a stainless steel layer and an aluminum alloy layer, wherein thickness T_{Al} (mm) and surface hardness H_{Al} (HV) of the aluminum alloy layer and thickness T_{SUS} (mm) and surface hardness H_{SUS} (HV) of the stainless steel layer satisfy the correlation represented by Formula (1): H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354). This invention also concerns an electronic device housing.

### TECHNICAL FIELD

The present invention relates to a roll-bonded laminate for an electronic device and an electronic device housing.

### BACKGROUND ART

A housing for a mobile electronic device (mobile terminal) represented by a mobile phone is made of resin such as ABS or a metallic material such as aluminum. Electronic devices have sophisticated functions in recent years. Accordingly, the battery capacity and the number of components mounted inside a device have increased, and a larger inner capacity has been required. In order to provide a larger inner capacity, it is necessary to further reduce housing thickness.

Patent Literature 1 and Patent Literature 2 each disclose an electronic device housing composed of resin. While resin is lightweight, use of resin for a housing is problematic in terms of appearance. Specifically, it is impossible to create a high-class look because a metallic appearance cannot be shown. In addition, a resin housing is inferior to a metal housing in terms of tensile strength, an elastic modulus, and impact strength. In order to improve such properties, accordingly, it is necessary to increase housing thickness. As described above, however, an inner capacity decreases as housing thickness increases.

Also, a housing may suffer from cracks depending on a size of a load applied to the housing. In addition, it is difficult to achieve electromagnetic shielding properties or electric grounds, it is necessary to allow a metal or a metal foil to be vapor-deposited or adhere inside the resin housing, and recyclability is thus poor. Further, radiation performance of a resin housing is inferior to that of a metal housing.

Patent Literature 3 discloses an electronic device housing composed of aluminum or an aluminum alloy. With the use of aluminum, a lightweight electronic device housing that is excellent in radiation performance and has a metallic appearance can be obtained. As a method of processing a housing made of an aluminum alloy, an aluminum alloy is grounded from an inner surface of the housing. In recent years, further reduction is required in weight, thickness, and size of a metallic material used for the housing. To this end, aluminum alloys of 6000 series and 7000 series that are less likely to deform are used. However, such aluminum alloys that are less likely to deform are very poor in press workability, a method of processing thereof into a housing is limited to grinding, and it is difficult to subject an aluminum alloy to press working that is superior to grinding in terms of cost, productivity, and other properties. In addition, an outer surface of the housing made of aluminum is poor in corrosion resistance in that state. Thus, alumite treatment that also serves as coloring is necessary, and it has been difficult to achieve a glossy appearance with the use of aluminum by itself. While stainless steel can create a glossy appearance, it is overweight and poor in radiation properties. Thus, use thereof for a housing has been difficult.

As metallic materials used for housings, roll-bonded laminates (e.g., metal laminated materials or clad materials) comprising two or more types of metal plates or metal foils laminated on top of each other are known. A roll-bonded laminate is a high-performance metallic material having combined properties that cannot be achieved with the use of a single type of material. For example, a roll-bonded laminate comprising stainless steel and aluminum laminated on top of each other has been examined.

Patent Literature 4 discloses a roll-bonded laminate with improved tensile strength, which comprises stainless steel and aluminum laminated on top of each other. Specifically, such laminate is a metal laminate of a bi-layer structure composed of a stainless steel layer and an aluminum layer or a tri-layer structure composed of a first stainless steel layer, an aluminum layer, and a second stainless steel layer. Such metal laminate exhibits tensile strength TS of 200 MPa to 550 MPa, elongation EL of 15% or more, and surface hardness HV of the stainless steel layer of 300 or lower.

While Patent Literature 4 discloses improvement in tensile strength and other properties of a roll-bonded laminate composed of stainless steel and aluminum, applications of a housing are not specifically examined. The roll-bonded laminate specifically disclosed in Patent Literature 4 exhibits high tensile strength; however, rigidity and an elastic modulus are not sufficient. Thus, such laminate is easily bent when a load is applied thereto from the outside, and it is not suitable for housing applications. That is, a method for producing a roll-bonded laminate composed of stainless steel and aluminum, which exhibits high rigidity and a high elastic modulus and is suitable for housing applications, has not yet been known.

### CITATION LIST

### Patent Literature

Patent Literature 1: JP 2005-149462 A

Patent Literature 2: JP Patent No. 5,581,453

Patent Literature 3: JP 2002-64283 A

Patent Literature 4: WO 2017/057665

### SUMMARY OF INVENTION

### Technical Problem

As described above, conventional roll-bonded laminates composed of stainless steel and aluminum had not been examined in terms of improvement of rigidity and an elastic modulus. Therefore, the present invention is intended to provide a roll-bonded laminate for an electronic device, which exhibits high rigidity and a high elastic modulus and is suitable for housing applications, and an electronic device housing.

### Solution to Problem

The present inventors have conducted concentrated studies in order to resolve the problem described above. As a result, they discovered that adjustment of thickness and surface hardness of an aluminum alloy layer and those of a stainless steel layer constituting a roll-bonded laminate to satisfy a particular correlation would be critical for improvement of rigidity and an elastic modulus. This has led to the completion of the present invention. Specifically, the present invention is summarized as follows.

(1) A roll-bonded laminate for an electronic device composed of a stainless steel layer and an aluminum alloy layer, wherein thickness T_{Al} (mm) and surface hardness H_{Al} (HV) of the aluminum alloy layer and thickness T_{SUS} (mm) and surface hardness H_{SUS} (HV) of the stainless steel layer satisfy the correlation represented by Formula (1) below.

H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (1)

(2) The roll-bonded laminate for an electronic device according to (1), which satisfy the correlation represented by Formula (2) below.

H_{SUS}T_{SUS}²≥(44.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (2)

(3) The roll-bonded laminate for an electronic device according to (1) or (2), wherein the proportion of thickness T_{SUS} of the stainless steel layer to the total thickness of the roll-bonded laminate is 10% to 85%.
(4) An electronic device housing mainly composed of a metal comprising a roll-bonded laminate composed of a stainless steel layer and an aluminum alloy layer at least on its back surface, wherein thickness T_{Al} (mm) and surface hardness H_{Al} (HV) of the aluminum alloy layer and thickness T_{SUS} (mm) and surface hardness H_{SUS} (HV) of the stainless steel layer satisfy the correlation represented by Formula (1) below.

H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (1)

(5) The electronic device housing according to (4), which satisfies the correlation represented by Formula (2) below.

H_{SUS}T_{SUS}²≥(44.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (2)

(6) The electronic device housing according to (4) or (5), wherein the proportion of thickness T_{SUS} of the stainless steel layer to the total thickness of the electronic device housing is 10% to 85%.

This description includes part or all of the content as disclosed in Japanese Patent Application Nos. 2017-066268, 2017-148053, and 2017-246865, which are priority documents of the present application.

### Advantageous Effects of Invention

The present invention can provide a roll-bonded laminate for an electronic device, which exhibits high rigidity and a high elastic modulus and is suitable for housing applications. This roll-bonded laminate can be suitably used as a component of an electronic device, and, in particular, an electronic device, such as a housing or an inner reinforcement member of a mobile electronic device, such as a smartphone or tablet (a mobile terminal), with the utilization of high rigidity and a high elastic modulus.

### BRIEF DESCRIPTION OF DRAWINGS

FIG. 1 shows a chart showing bending stress and bending strain determined by measuring the roll-bonded laminate of Example 6 from the stainless steel layer side.

FIG. 2 shows a chart demonstrating the correlation between surface hardness H_{Al}×thickness T_{Al}² of the aluminum alloy layer and the load at 0.2% proof stress under two conditions in which surface hardness H_{SUS} and thickness T_{SUS} of the stainless steel layer are constant.

FIG. 3 shows a chart demonstrating the correlation between surface hardness H_{SUS}×thickness T_{SUS}² of the stainless steel layer and surface hardness H_{Al}×thickness T_{Al}² of the aluminum alloy layer of the roll-bonded laminates of Examples 1 to 14 and Comparative Examples 1 to 5 and the electronic device housing of Example 15.

FIG. 4 is a perspective view showing the electronic device housing according to an embodiment of the present invention.

FIG. 5 is a perspective, cross-sectional view showing the electronic device housing according to the first embodiment of the present invention taken in the X-X′ direction.

### DESCRIPTION OF EMBODIMENTS

Hereafter, the present invention is described in detail.

### 1. Roll-Bonded Laminate

The roll-bonded laminate of the present invention is composed of a stainless steel layer and an aluminum alloy layer. Accordingly, the roll-bonded laminate of the present invention comprises 2 or more layers, preferably 2 to 4 layers, more preferably 2 or 3 layers, and particularly preferably 2 layers. A roll-bonded laminate according to a preferable embodiment is a bi-layer roll-bonded laminate composed of a stainless steel layer and an aluminum alloy layer, a tri-layer roll-bonded laminate composed of a stainless steel layer, an aluminum alloy layer, and a stainless steel layer, or a tri-layer roll-bonded laminate composed of an aluminum alloy layer, a stainless steel layer, and an aluminum alloy layer. When a stainless steel layer or an aluminum alloy layer is used as an exterior of a housing comprising a roll-bonded laminate, the appearance of the housing can exhibit metallic luster. When higher luster is intended, an exterior of the housing is preferably made of a stainless steel layer. In the present invention, a constitution of the roll-bonded laminate can be selected in accordance with a purpose or properties of interest of the roll-bonded laminate.

As an aluminum alloy, a plate material comprising at least one additive metal element other than aluminum can be used. An additive metal element is preferably Mg, Mn, Si, or Cu. The total content of the additive metal elements in an aluminum alloy preferably exceeds 0.5% by mass, and it more preferably exceeds 1% by mass. An aluminum alloy preferably comprises at least one additive metal element selected from Mg, Mn, Si, and Cu exceeding 1% by mass in total.

For example, aluminum alloys defined by JIS, such as Al—Cu-base alloy (2000 series), Al—Mn-base alloy (3000 series), Al—Si-base alloy (4000 series), Al—Mg-base alloy (5000 series), Al—Mg—Si-base alloy (6000 series), and Al—Zn—Mg-base alloy (7000 series), can be used. From the viewpoint of press workability, strength, corrosion resistance, and bending rigidity, aluminum alloys of 3000 series, 5000 series, 6000 series, and 7000 series are preferable. From the viewpoint of the balance between such properties and cost, an aluminum alloy of 5000 series is more preferable. An aluminum alloy preferably contains Mg in an amount of 0.3% by mass or more.

As stainless steel constituting a stainless steel layer, for example, a stainless steel plate SUS304, SUS201, SUS316, SUS316L, or SUS430 can be used, although stainless steel is not limited thereto. An annealed material (O material) or ½H material is preferable in order to retain adhesion strength at the time of roll bonding or clad bonding.

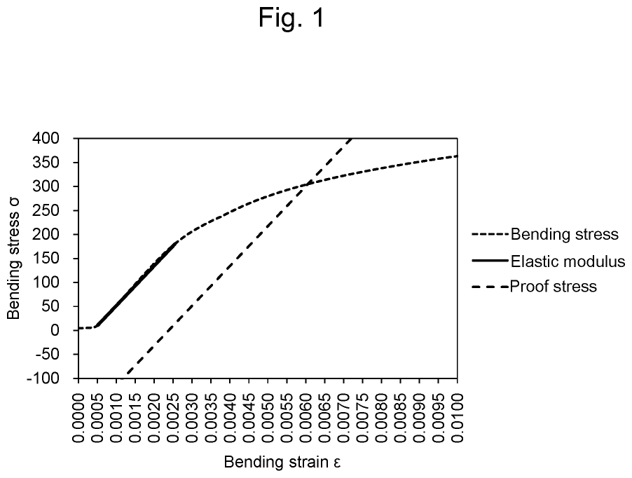

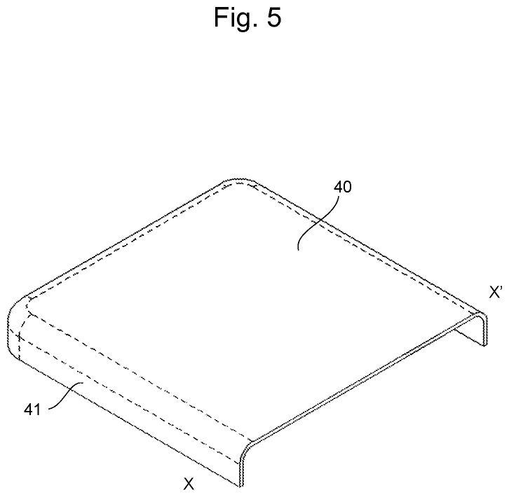

In the present invention, a load at 0.2% proof stress (i.e., a maximum strain in the elastic range) was used as the indicator of rigidity of the roll-bonded laminate. The load and the elastic modulus at 0.2% proof stress can be determined in accordance with JIS K 7171 (Plastics—Determination of bending properties) and JIS Z 2241 (Metallic materials—Method of tensile testing). Specifically, a test piece of a width of 20 mm is prepared from the roll-bonded laminate, and the test piece is subjected to the three-point bending test using a universal testing machine, TENSILON RTC-1350A (manufactured by Orientec Corporation), in accordance with JIS K 7171 (Plastics—Determination of bending properties) and JIS Z 2248 (Metallic materials—Method of bend testing) to measure the bending load and the bending deflection. The three-point bending test is carried out with reference to FIG. 5 of JIS Z 2248 by designating the radius of the press tool as 5 mm, the support radius as 5 mm, and the support span as 40 mm. With the use of the terms and the definitions used in JIS K 7171, subsequently, the bending stress σ is determined based on the bending load in accordance with the formula: bending stress σ=3FL/2bh² (wherein F represents a bending load, L represents a support span, b represents a test piece width, and h represents a test piece thickness (total thickness)). Also, the bending strain ε is determined based on the bending deflection in accordance with the formula: bending strain ε=600 sh/L² (wherein s represents bending deflection, h represents a test piece thickness (total thickness), and L represents a support span)). Thus, a chart demonstrating the bending stress and the bending strain is obtained. In the chart demonstrating the bending stress σ and the bending strain E, deflection in the bending stress in a region in which the bending strain ε is from 0.0005 to 0.0025 (0.05% to 0.25%) (slope: Δσ/Δε) is determined and designated as an elastic modulus. An elastic modulus serves as an indicator of difficulty of deformation when a given load is applied in the elastic range (i.e., the elastic deformation range). When an elastic modulus is high, specifically, elastic deformation caused by an external load can be small. When an elastic modulus is excessively low, in contrast, an extent of deformation becomes increased. Even if deformation is resolved after the load is removed, an internal electronic components may be affected by deformation in the elastic range while the load is applied. An elastic modulus is preferably 60 GPa or higher, and more preferably 70 GPa or higher, which is equivalent to that of a general high-strength material; i.e., A6061-T6. Bending stress at a point where a line moved from the line indicating the elastic modulus in parallel by +0.002 (+0.2%) in terms of the amount of bending strain is crossed with a curved line indicating bending stress is designated as a 0.2% proof stress. A load F at 0.2% proof stress is determined in accordance with a 0.2% proof stress and the formula: bending stress σ=3 FL/2bh² (wherein F represents a bending load, L represents a support span, b represents a test piece width, and h represents a test piece thickness (total thickness)) (see FIG. 1). The load F at 0.2% proof stress can be regarded as the maximum load of the material composition in the elastic range. As such value is increased, accordingly, an elastic range can be expanded. Specifically, plastic deformation is less likely to be caused by an external load. The load F is preferably 35 N/20 mm or higher, and more preferably 45 N/20 mm or higher.

The present inventors examined factors that would significantly contribute to rigidity and an elastic modulus of the roll-bonded laminate composed of a stainless steel layer and an aluminum alloy layer. As a result, they discovered that rigidity and an elastic modulus could be improved when thickness T_{Al} (mm) of the aluminum alloy layer, surface hardness H_{Al} (HV) of the aluminum alloy layer, thickness T_{SUS} (mm) of the stainless steel layer, and surface hardness H_{SUS} (HV) of the stainless steel layer satisfied a particular correlation.

Specifically, the load F (N) at 0.2% proof stress used as an indicator of rigidity is represented by Formula (3) below in terms of the correlation among thickness T_{Al} (mm) of the aluminum alloy layer, surface hardness H_{Al} (HV) of the aluminum alloy layer, thickness T_{SUS} (mm) of the stainless steel layer, and surface hardness H_{SUS} (HV) of the stainless steel layer.

F=(−0.008×H_{SUS}T_{SUS}²−0.03)×(H_{Al}T_{Al}²)²+(0.061×H_{SUS}T_{SUS}²+3.57)×H_{Al}T_{Al}²+1.354×H_{SUS}T_{SUS}²+0.04: Formula (3)

The present inventors discovered that, on the basis of Formula (3), a roll-bonded laminate composed of a stainless steel layer and an aluminum alloy layer that satisfies the correlation represented by Formula (1) in terms of thickness T_{Al} (mm) of the aluminum alloy layer, surface hardness H_{Al} (HV) of the aluminum alloy layer, thickness T_{SUS} (mm) of the stainless steel layer, and surface hardness H_{SUS} (HV) of the stainless steel layer would exhibit a high load of 35 N/20 mm or higher at 0.2% proof stress, high rigidity, and a high elastic modulus, and such laminate would be suitable for housing applications.

H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (1)

In addition, the roll-bonded laminate that satisfies the correlation represented by Formula (2) would exhibit a higher load of 45 N/20 mm or higher at 0.2% proof stress and higher rigidity, and it is particularly suitable for housing applications.

H_{SUS}T_{SUS}²≥(44.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (2)

It should be noted that such correlations concern aluminum alloys and such correlations may not be applicable when an aluminum material is pure aluminum.

According to the present invention, a roll-bonded laminate exhibiting high rigidity and a high elastic modulus while retaining sufficient bonding strength can be obtained by adjusting thickness T_{Al} (mm) of the aluminum alloy layer, surface hardness H_{Al} (HV) of the aluminum alloy layer, thickness T_{SUS} (mm) of the stainless steel layer, and surface hardness H_{SUS} (HV) of the stainless steel layer to satisfy the correlation represented by Formula (1).

Thickness T_{SUS}+T_{Al} of the roll-bonded laminate is not particularly limited. In general, the upper limit of such thickness is 1.6 mm or less, preferably 1.2 mm or less, more preferably 1.0 mm or less, and further preferably 0.8 mm or less, and the lower limit is 0.2 mm or more, preferably 0.3 mm or more, and more preferably 0.4 mm or more. Thickness of the roll-bonded laminate is preferably 0.2 mm to 1.6 mm, more preferably 0.3 mm to 1.2 mm, further preferably 0.4 mm to 1.0 mm, and still further preferably 0.4 mm to 0.8 mm. Thickness of the roll-bonded laminate is total thickness of the stainless steel layer and the aluminum alloy layer. Thickness is determined by measuring thickness of the roll-bonded laminate at arbitrary 30 points thereon with the use of, for example, a micrometer and calculating the average thereof.

In general, a stainless steel layer with thickness T_{SUS} of 0.05 mm or more can be used. From the viewpoint of moldability and strength, the lower limit is preferably 0.1 mm or more. While the upper limit is not particularly limited, elongation and moldability may be deteriorated when a stainless steel layer is excessively thick relative to an aluminum alloy layer. Thus, the upper limit is preferably 0.6 mm or less, and more preferably 0.5 mm or less. When weight reduction is further intended, the upper limit is particularly preferably 0.4 mm or less. Thickness T_{SUS} of a stainless steel layer is preferably 0.05 mm to 0.6 mm, more preferably 0.1 mm to 0.5 mm, and further preferably 0.1 mm to 0.4 mm. When a roll-bonded laminate comprises 2 or more stainless steel layers, stainless steel layer thickness of the roll-bonded laminate is thickness of each stainless steel layer. Stainless steel layer thickness can be determined in the same manner as in the case of the aluminum alloy layer described below.

The proportion T_{SUS}/(T_{SUS}+T_{Al}) of thickness of the stainless steel layer relative to thickness (total thickness) of the roll-bonded laminate is preferably 10% to 85%, and more preferably 10% to 70%. When the proportion of stainless steel layer thickness is within such range, an elastic modulus is increased, and the roll-bonded laminate is more suitable for housing applications. In the presence of 2 or more stainless steel layers, the term “the proportion of stainless steel layer thickness” refers to a proportion of total thickness of the stainless steel layers relative to thickness of the roll-bonded laminate.

Surface hardness H_{SUS} (HV) of the stainless steel layer is preferably 180 or more, and more preferably 200 or more. From the viewpoint of moldability, in contrast, surface hardness of the stainless steel layer is preferably lower. Thus, surface hardness H_{SUS} (HV) of the stainless steel layer is preferably 350 or less, and more preferably 330 or less. Surface hardness H_{SUS} (HV) of the stainless steel layer is preferably 180 to 350, and more preferably 200 to 330. When surface hardness of the stainless steel layer is within such range, the roll-bonded laminate can achieve high rigidity, a high elastic modulus, and moldability. In the present invention, surface hardness of a stainless steel layer can be measured with the use of, for example, Micro Vickers hardness tester (load: 200 gf) in accordance with JIS Z 2244 (Vickers hardness test—Test method). When the roll-bonded laminate of the present invention comprises 2 or more stainless steel layers, it is preferable that each stainless steel layer has the surface hardness as described above.

In general, an aluminum alloy layer with thickness T_{Al} of 0.1 mm or more can be used. From the viewpoint of mechanical strength and workability, thickness is preferably 0.12 mm or more, and more preferably 0.15 mm or more. From the viewpoint of weight reduction and cost, thickness is preferably 1.1 mm or less, more preferably 0.9 mm or less, and further preferably 0.72 mm or less. Thickness T_{Al} of an aluminum alloy layer is preferably 0.1 mm to 1.1 mm, more preferably 0.12 mm to 0.9 mm, and further preferably 0.15 mm to 0.72 mm. When a roll-bonded laminate comprises 2 or more aluminum alloy layers, thickness of the aluminum alloy layer of the roll-bonded laminate is thickness of each aluminum alloy layer. Thickness of an aluminum alloy layer is determined by obtaining an optical microscopic photograph of a cross section of the roll-bonded laminate, measuring thickness of the aluminum alloy layer at arbitrary 10 points in the optical microscopic photograph, and calculating the average thickness.

Surface hardness H_{Al} (HV) of the aluminum alloy layer is not particularly limited. It is preferably 40 to 90, and more preferably 45 to 90. In the present invention, surface hardness of an aluminum alloy layer can be measured with the use of Micro Vickers hardness tester (load: 50 gf) in accordance with JIS Z 2244 (Vickers hardness test—Test method). When the roll-bonded laminate of the present invention comprises 2 or more aluminum alloy layers, each aluminum alloy layer has the surface hardness as described above.

The roll-bonded laminate has a load at 0.2% proof stress, which is preferably 35 N/20 mm or higher, and more preferably 45 N/20 mm or higher. A load at 0.2% proof stress is a value determined by measuring a load applied from one surface of the roll-bonded laminate. In this case, a surface that is brought into contact with a press tool used for the three-point bending test is an outer surface after processing to a housing.

The roll-bonded laminate exhibits an elastic modulus, which is preferably 60 GPa or higher, and more preferably 70 GPa or higher. An elastic modulus is a value determined by measuring a load applied from one surface of the roll-bonded laminate. In this case, a surface that is brought into contact with a press tool used for the three-point bending test is an outer surface after processing to a housing. While the upper limit of an elastic modulus is not particularly limited, an elastic modulus is preferably 175 GPa or lower because an elastic modulus of stainless steel (e.g., 0.5 mm-thick SUS304, BA material) is approximately 175 GPa.

The peel strength (180 peel strength, also referred to as “peel strength of 180 degrees”) of the roll-bonded laminate is preferably 40 N/20 mm or higher. From the viewpoint of excellent press workability, the peel strength of the roll-bonded laminate is more preferably 60 N/20 mm or higher. The peel strength can be used as an indicator of adhesion strength. In the case of a roll-bonded laminate composed of 3 or more layers, the peel strength is preferably 60 N/20 mm or higher at each bonding interface. When the peel strength is improved to a significant extent, the material would be broken instead of peeling. Thus, there is no upper limit of the peel strength.

In the present invention, the peel strength of the roll-bonded laminate is determined by preparing a test piece of a width of 20 mm from the roll-bonded laminate, partly separating the stainless steel layer from the aluminum alloy layer, fixing the thick layer side or hard layer side, and measuring the force required to pull one layer from the fixed side in the direction 180 degrees opposite therefrom. The peel strength is represented in terms of “N/20 mm.” When a similar test is performed with the use of a test piece of a width of 10 mm to 30 mm, peel strength would not change.

The roll-bonded laminate preferably has the elongation of 35% or higher, and more preferably 40% or higher from the viewpoint of satisfactory press workability, measured by a tensile test involving the use of a test piece of a width of 15 mm. The elongation can be measured by a tensile test in accordance with the measurement of elongation at break defined by JIS Z 2241 or JIS Z 2201 with the use of, for example, the test piece for the tensile strength test described below.

The roll-bonded laminate preferably exhibits tensile strength of 3,000 N or higher, and more preferably 3,500 N or higher from the viewpoint of sufficient strength and press workability, measured by a tensile test involving the use of a test piece of a width of 15 mm. The term “tensile strength” used herein refers to the maximal load applied in the tensile test. The tensile strength can be measured with the use of, for example, a universal testing machine, TENSILON RTC-1350A (manufactured by Orientec Corporation), in accordance with JIS Z 2241 or JIS Z 2201 (Metallic materials—Method of tensile testing). A width of the test piece (15 mm) is the width specified for Special Test Piece No. 6 by JIS Z 2201. When measurement is carried out in accordance with JIS Z 2241, for example, Test Piece No. 5 can be used. The tensile strength determined with the use of Test Piece No. 6 may be converted into the tensile strength determined with the use of Test Piece No. 5 by multiplying a factor of the test piece width; i.e., 25 mm/15 mm, which is about 1.66 times.

The roll-bonded laminate preferably exhibits elongation of 35% or more measured by the tensile test and tensile strength of 3,000 N or higher measured by the tensile test.

A roll-bonded laminate exhibiting elongation of 35% or more measured by a tensile test and/or tensile strength of 3,000 N measured by a tensile test is preferable because it is easily formed into a housing. In the case of a housing using a roll-bonded laminate (e.g., a back surface of a housing comprising a roll-bonded laminate on its back surface), it is not necessary that the roll-bonded laminate satisfies the preferable conditions concerning elongation and tensile strength measured by the tensile test.

### 2. Electronic Device Housing

The present invention also concerns an electronic device housing comprising the roll-bonded laminate as described above. The electronic device housing is mainly composed of a metal, and it comprises the roll-bonded laminate on its back surface and/or a side surface. Specifically, the electronic device housing comprises the roll-bonded laminate on the back surface and the side surface or a part thereof. Basically, the electronic device housing of the present invention has properties similar to those of the roll-bonded laminate, and the properties and the embodiments concerning the roll-bonded laminate described above are applicable to the electronic device housing. Specifically, the electronic device housing of the present invention has thickness T_{Al} (mm) of the aluminum alloy layer, surface hardness H_{Al} (HV) of the aluminum alloy layer, thickness T_{SUS} (mm) of the stainless steel layer, and surface hardness H_{SUS} (HV) of the stainless steel layer satisfying the correlation represented by Formula (1).

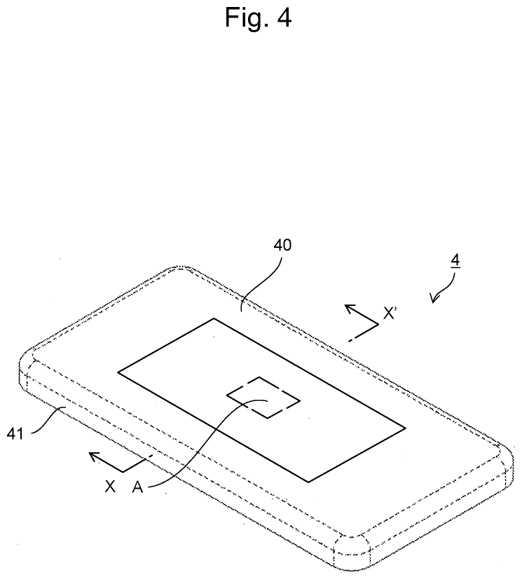

FIG. 4 and FIG. 5 show a first embodiment of the electronic device housing using the roll-bonded laminate of the present invention. FIG. 4 shows a perspective view of a first embodiment of the electronic device housing using the roll-bonded laminate of the present invention, and FIG. 5 shows a perspective, cross-sectional view of a first embodiment of the electronic device housing using the roll-bonded laminate of the present invention taken in the X-X′ direction. An electronic device housing 4 is composed of a back surface 40 and a side surface 41, and the entire back surface 40 and side surface 41 or a part thereof can comprise the roll-bonded laminate composed of a stainless steel layer and an aluminum alloy layer. As shown in FIG. 4, the back surface 40 is a surface opposite from the surface of the housing constituting an electronic device such as a smartphone (i.e., a mobile terminal) on which a display (not shown) is provided. The electronic device housing 4 may comprise a metal or plastic material provided on its inner surface separately from the roll-bonded laminate. When the electronic device housing 4 comprises the roll-bonded laminate on the back surface 40, it is sufficient if the entire back surface 40 or a part thereof (e.g., a plane region of 2 cm×2 cm or larger, such as a plane region of 25 mm×25 mm, shown as a plane region A in FIG. 4) has sufficient properties of the roll-bonded laminate in terms of thickness, surface hardness, and a load at 0.2% proof stress and an elastic modulus. When an aluminum alloy layer of the roll-bonded laminate is subjected to processing, such as grinding, or surface treatment, such as polishing or coating, when producing a housing, the resulting properties, such as thickness, hardness, and mechanical strength, may differ from those of the roll-bonded laminate. Preferable embodiments of the electronic device housing are described below. While the electronic device housing 4 is constituted to comprise the roll-bonded laminate on its back surface 40, the structure of the housing is not limited thereto depending on the structure of the electronic device. The back surface 40 and the side surface 41 may be each composed of the roll-bonded laminate, or the side surface 41 may comprise the roll-bonded laminate.

Subsequently, a second embodiment of the electronic device housing using the roll-bonded laminate of the present invention is described. According to the present embodiment, an electronic device housing as a central frame is sandwiched by a display such as a glass or resin display and a back surface, an electronic device housing is composed of a side surface and an inner reinforcement frame connected to the side surface, and the inner reinforcement frame constitutes the back surface of the electronic device housing. The side surface and the inner reinforcement frame or a part thereof of the electronic device housing can comprise the roll-bonded laminate of the present invention composed of a stainless steel layer and an aluminum alloy layer. The “inner reinforcement frame” is a support plate that is located inside an electronic device such as a smartphone and plays a role for improving rigidity of the entire electronic device and as a support comprising components such as a battery or a printed substrate mounted thereon. In general, the inner reinforcement frame comprises holes for connection or assembly. A hole can be made by press working or other means. According to the present embodiment, the side surface may or may not be integrated with the inner reinforcement frame. Also, the roll-bonded laminate may be selectively used for the side surface. It should be noted that the electronic device housing according to the present embodiment can be adequately modified in accordance with the structure of the electronic device as with the case of the electronic device housing 4 and that the structure thereof is not limited to those described above.

While thickness T_{SUS}+T_{Al} of the electronic device housing is not particularly limited, in general, the upper limit of thickness is 1.2 mm or less, preferably 1.0 mm or less, more preferably 0.8 mm or less, and further preferably 0.7 mm or less, so as to increase the inner capacity. The lower limit is 0.2 mm or more, preferably 0.3 mm or more, and more preferably 0.4 mm or more. Thickness of the electronic device housing is thickness of all the layers including the roll-bonded laminate on the back surface of the housing (i.e., thickness in a plane region of 2 cm×2 cm or larger, such as a plane region of 25 mm×25 mm, shown as a plane region A in FIG. 4). Thickness of the electronic device housing is determined by measuring thickness thereof at arbitrary 30 points on its back surface with the use of a micrometer and calculating the average thereof.

In general, a stainless steel layer with thickness T_{SUS} of 0.05 mm or more can be used. From the viewpoint of moldability and strength, the lower limit is preferably 0.1 mm or more. While the upper limit is not particularly limited, elongation and moldability may be deteriorated when a stainless steel layer is excessively thick relative to the aluminum alloy layer. Thus, the upper limit is preferably 0.6 mm or less, and more preferably 0.5 mm or less. When weight reduction is further intended, the upper limit is particularly preferably 0.4 mm or less. Thickness T_{SUS} of a stainless steel layer is preferably 0.05 mm to 0.6 mm, more preferably 0.1 mm to 0.5 mm, and further preferably 0.1 mm to 0.4 mm.

The proportion T_{SUS}/(T_{SUS}+T_{Al}) of thickness of the stainless steel layer relative to thickness (total thickness) of the roll-bonded laminate is preferably 10% to 85%, and more preferably 10% to 70%.

Surface hardness H_{SUS} (HV) of a stainless steel layer is preferably 180 or more, and more preferably 200 or more. From the viewpoint of moldability, in contrast, surface hardness of the stainless steel layer is preferably lower. Thus, surface hardness H_{SUS} (HV) of the stainless steel layer is preferably 350 or less, and more preferably 330 or less. Surface hardness H_{SUS} (HV) of the stainless steel layer is preferably 180 to 350, and more preferably 200 to 330. When surface hardness of the stainless steel layer is within such range, the electronic device housing can achieve high rigidity, a high elastic modulus, and moldability.

In general, an aluminum alloy layer with thickness T_{Al} of 0.1 mm or more can be used. From the viewpoint of mechanical strength and workability, thickness is preferably 0.12 mm or more, and more preferably 0.15 mm or more. From the viewpoint of weight reduction and cost, thickness is preferably 1.1 mm or less, more preferably 0.9 mm or less, and further preferably 0.72 mm or less. Thickness T_{Al} of an aluminum alloy layer is preferably 0.1 mm to 1.1 mm, more preferably 0.12 mm to 0.9 mm, and further preferably 0.15 mm to 0.72 mm.

Surface hardness H_{Al} (HV) of an aluminum alloy layer is not particularly limited. It is preferably 40 to 90, and more preferably 45 to 90.

The electronic device housing preferably has a load of 35 N/20 mm or higher, and more preferably 45 N/20 mm or higher at 0.2% proof stress.

The electronic device housing preferably has an elastic modulus of 60 GPa or higher, and more preferably 70 GPa or higher.

The electronic device housing preferably has the peel strength of 40 N/20 mm or higher, and more preferably 60 N/20 mm or higher. The peel strength of of the electronic device housing can be determined by cutting the roll-bonded laminate from the electronic device housing and measuring the peel strength thereof in the same manner as in the case of the roll-bonded laminate described above.

### 3. Methods for Producing the Roll-Bonded Laminate and the Electronic Device Housing

The roll-bonded laminate can be obtained by preparing a stainless steel plate and an aluminum alloy plate and roll-bonding the same in the manner described below.

In the case of cold roll bonding, the surface of the stainless steel plate and that of the aluminum alloy plate to be bonded to each other are subjected to brush polishing or other means, the stainless steel plate and the aluminum alloy plate are superposed on top of each other and bonded to each other via cold rolling, and the resultant is then subjected to annealing. Thus, the laminate of interest can be prepared. Cold roll bonding may comprise a plurality of steps, and annealing may be followed by conditioning. According to such technique, roll bonding is carried out to a final reduction ratio of 20% to 90% (i.e., a reduction ratio determined based on the thickness of the original plates before bonding and that of the roll-bonded laminate). When producing the laminate via cold roll bonding, thickness of the original stainless steel plate is 0.0125 mm to 6 mm, preferably 0.056 mm to 5 mm, and more preferably 0.063 mm to 4 mm, and thickness of the original aluminum alloy plate is 0.063 mm to 25 mm, preferably 0.13 mm to 17 mm, and more preferably 0.25 mm to 11 mm from the viewpoint of the reduction ratio described above.

In the case of hot roll bonding, the surfaces to be bonded to each other are subjected to brush polishing or other means as in the case of cold roll bonding, either or both surfaces is/are heated to 200° C. to 500° C., and the plates are superposed on top of each other and bonded to each other via hot roll bonding. Thus, the laminate of interest can be prepared. According to this technique, a final reduction ratio is approximately 15% to 40%. When producing the laminate via hot roll bonding, thickness of the original stainless steel plate is 0.012 mm to 1 mm, preferably 0.053 mm to 0.83 mm, and more preferably 0.059 mm to 0.067 mm, and thickness of the original aluminum alloy plate is 0.059 mm to 4.2 mm, preferably 0.19 mm to 2.8 mm, and more preferably 0.24 mm to 1.8 mm from the viewpoint of the reduction ratio described above.

In the case of surface-activated bonding in vacuum (hereafter, it is also referred to as “surface-activated bonding”), the laminate can be produced by a method comprising: a step of subjecting the surface of the stainless steel plate and that of the aluminum alloy plate to be bonded to each other to sputter-etching; a step of roll bonding the surfaces subjected to sputter-etching to each other at a light reduction ratio of the stainless steel layer to 0% to 25%; and a step of performing batch thermal treatment at 200° C. to 400° C. or continuous thermal treatment at 300° C. to 890° C. In this method of production, the number of layers of a roll-bonded laminate can be varied in accordance with the number of repetitions of the steps of sputter-etching and the steps of bonding performed. For example, a bi-layer roll-bonded laminate can be produced by a step of sputter-etching in combination with bonding, followed by thermal treatment. A tri-layer roll-bonded laminate can be produced by repeating a step of sputter-etching in combination with bonding two times, followed by thermal treatment.

As described above, a method of bonding to obtain a laminate is not particularly limited. When hardness of stainless steel is excessively increased, toughness is deteriorated, and stainless steel becomes easy to break. In the case of a laminate of an aluminum alloy and stainless steel, in addition, it is difficult to perform softening annealing of stainless steel after bonding. In any bonding method, accordingly, the final reduction ratio is preferably 40% or lower, more preferably 30% or lower, and further preferably 25% or lower. When a reduction ratio of a stainless steel layer is excessively increased, in particular, work hardening occurs to a significant extent, and toughness is deteriorated. Accordingly, a stainless steel layer becomes easy to crack at the time of roll bonding, handling, or use thereof for housing applications, and a reduction ratio of a stainless steel layer is thus preferably 35% or lower. Hereafter, a method of production via surface-activated bonding that can easily perform bonding at a low reduction ratio is described.

A stainless steel plate that can be used is the stainless steel plate described concerning the roll-bonded laminate above.

In general, thickness of a stainless steel plate before bonding may be 0.045 mm or more. The lower limit of thickness is preferably 0.06 mm or more, and more preferably 0.1 mm or more from the viewpoint of ease of handling in the form of a roll-bonded laminate, a sufficient thickness resistance to the maximum bending stress, and a grinding margin at the time of decoration or mirror-like finishing in the form of a housing. The upper limit is not particularly limited since the maximum bending stress can further be increased as a stainless steel proportion is increased. When stainless steel thickness is excessively large, the weight of the plate is increased. From the viewpoint of lightweight properties in the form of a housing, accordingly, thickness is preferably 0.6 mm or less, more preferably 0.5 mm or less, and further preferably 0.4 mm or less. Thickness of a stainless steel plate before bonding can be measured with the use of a micrometer, and it is an average of thickness values measured at 10 points randomly selected from the stainless steel plate surface.

Surface hardness (HV) of the stainless steel plate before bonding is preferably 160 or more, and more preferably 180 or more. In the present invention, hardness of the stainless steel layer of the roll-bonded laminate influences rigidity and an elastic modulus; however, the condition immediately before bonding and influence of hardening of stainless steel caused by strain at the time of bonding are considered to be more significant. Accordingly, it is preferable that hardness of the stainless steel plate be regulated to some extent before bonding. For this reason, surface hardness (HV) of the stainless steel plate is preferably 350 or less, and more preferably 330 or less. Surface hardness (HV) of the stainless steel plate is preferably 160 to 350, and more preferably 180 to 330, so that sufficient rigidity, an elastic modulus, and moldability can be achieved.

An aluminum alloy plate that can be used is the aluminum alloy plate described concerning the roll-bonded laminate above.

In general, thickness of an aluminum alloy plate before bonding may be 0.05 mm or more. The lower limit of thickness is preferably 0.1 mm or more, and more preferably 0.2 mm or more. The upper limit is generally 3.3 mm or less, preferably 1.5 mm or less, and more preferably 1.0 mm or less from the viewpoint of weight reduction and cost. Thickness of the aluminum alloy plate before bonding can be determined in the same manner as in the stainless steel plate described above.

At the time of sputter etching, the surface of the stainless steel plate and the surface of the aluminum alloy plate to be bonded to each other are subjected to sputter etching.

Specifically, sputter etching is carried out by preparing a stainless steel plate and an aluminum alloy plate as a long coil with a width of 100 mm to 600 mm, designating the stainless steel plate connected to the aluminum alloy plate as a ground-connected electrode, applying an alternating current of 1 MHz to 50 MHz to a region between the ground-connected electrode and the other insulated electrode to generate a glow discharge, and adjusting an area of the electrode exposed to the plasma generated by the glow discharge to one third or less of the area of the other electrode. During sputter-etching, the ground-connected electrode is in the form of a cooling roll, which prevents the transfer materials from temperature increase.

Sputter-etching treatment is intended to completely remove substances adsorbed to the surfaces and remove a part of or the entire oxide film on the surfaces by subjecting the surfaces of the stainless steel plate and the aluminum alloy plate to be bonded to each other to sputtering with inert gas in vacuum. It is not necessary to completely remove the oxide film, and the stainless steel layer can be sufficiently bonded to the aluminum alloy plate in the presence of a remaining part of the oxide film. In the presence of a remaining part of the oxide film, the duration of the sputter-etching treatment is shortened to a significant extent, and productivity of metal laminate materials is improved, compared to the case in which the oxide film is completely removed. Examples of inert gas that can be applied include argon, neon, xenon, krypton, and a mixed gas comprising at least one of the inert gases mentioned above. Substances adsorbed to the surface of the stainless steel plate or the aluminum alloy plate can be completely removed with the etching amount of about 1 nm (in terms of SiO₂).

In the case of a single plate, for example, the stainless steel plate can be subjected to sputter-etching in vacuum at a plasma output of 100 W to 1 kW for 1 to 50 minutes. In the case of a long material such as a line material, for example, it can be subjected to sputter-etching in vacuum at a plasma output of 100 W to 10 kW and a line velocity of 1 m/min to 30 m/min. While a higher degree of vacuum is preferable in order to prevent substances from being readsorbed to the surface, a degree of vacuum of, for example, 1×10⁻⁵ Pa to 10 Pa is sufficient. In sputter-etching, temperature of the stainless steel plate is preferably maintained at ordinary temperature to 150° C., so as to prevent the aluminum alloy plate from softening.

A stainless steel plate comprising an oxide film remaining in a part on its surface can be obtained by adjusting the etching amount of the stainless steel plate to, for example, 1 nm to 10 nm. According to need, the amount of etching may exceed 10 nm.

In the case of a single plate, for example, the aluminum alloy plate can be subjected to sputter-etching in vacuum at a plasma output of 100 W to 1 kW for 1 to 50 minutes. In the case of a long material such as a line material, for example, it can be subjected to sputter-etching at a plasma output of 100 W to 10 kW and a line velocity of 1 m/min to 30 m/min. While a higher degree of vacuum is preferable in order to prevent substances from being readsorbed to the surface, a degree of vacuum of 1×10⁻⁵ Pa to 10 Pa is sufficient.

An aluminum alloy plate comprising an oxide film remaining in a part on its surface can be obtained by adjusting the etching amount of the aluminum alloy plate to, for example, 1 nm to 10 nm. According to need, the amount of etching may exceed 10 nm.

The surface of the stainless steel plate and the surface of the aluminum alloy plate subjected to sputter etching are pressure-bonded, for example, roll-bonded to each other at a light reduction ratio of the stainless steel layer of 0% to 25%, and preferably 0% to 15%. Thus, the stainless steel plate is bonded to the aluminum alloy plate.

A reduction ratio of the stainless steel layer is determined based on thickness of the stainless steel plate before bonding and thickness of the stainless steel layer of the final form of the roll-bonded laminate. Specifically, the reduction ratio of the stainless steel layer is determined by the formula: (thickness of the stainless steel plate material before bonding—thickness of the stainless steel layer of the final form of the roll-bonded laminate)/thickness of the stainless steel plate material before bonding.

When a stainless steel layer is bonded to an aluminum alloy layer, an aluminum alloy layer is more easily deformed. A reduction ratio of a stainless steel layer is lower than a reduction ratio of an aluminum alloy layer. When a reduction ratio is high, work hardening easily occurs in the stainless steel layer. Thus, a reduction ratio is preferably 15% or lower, more preferably 10% or lower, and further preferably 8% or lower. It is not necessary that thickness vary before and after bonding. Accordingly, the lower limit of a reduction ratio is 0%. When hardness of the stainless steel plate is lower, work hardening is forced to occur, so as to improve rigidity and an elastic modulus. In such a case, a reduction ratio is preferably 0.5% or higher, more preferably 2% or higher, and further preferably 3% or higher. A reduction ratio of a stainless steel layer is preferably 0% to 15%, so as to achieve high rigidity and a high elastic modulus while suppressing work hardening. According to the method of surface-activated bonding, in particular, a reduction ratio can be 10% or lower. Thus, stainless steel hardening can be more sufficiently suppressed.

In the method of production according to the present invention, a reduction ratio of an aluminum alloy layer is not particularly limited; however, it is preferably 5% or higher, more preferably 10% or higher, and more preferably 12% or higher, so as to retain the bonding force before thermal diffusion treatment. When a reduction ratio of an aluminum alloy layer is 5% or higher, the peel strength is improved after the thermal treatment. A reduction ratio of an aluminum alloy layer is determined based on thickness of the aluminum alloy plate before bonding and thickness of the aluminum alloy layer in the final form of the roll-bonded laminate. Specifically, a reduction ratio of an aluminum alloy layer is determined in accordance with the formula: (thickness of the aluminum alloy plate material before bonding—thickness of the aluminum alloy layer in the final form of the roll-bonded laminate)/thickness of the aluminum alloy plate material before bonding.

The upper limit of the reduction ratio of the aluminum alloy layer is not particularly limited. For example, it is 70% or lower, preferably 50% or lower, and more preferably 40% or lower, and such preferable level is not limited to the case of surface-activated bonding. When the upper limit of the reduction ratio of the aluminum alloy layer is at the level mentioned above, the bonding force can be easily retained while maintaining thickness precision. According to surface-activated bonding, in particular, the reduction ratio can be 18% or lower, and the aluminum alloy layer can be maintained flat more sufficiently.

According to surface-activated bonding, the reduction ratio of the roll-bonded laminate is preferably 40% or lower, more preferably 15% or lower, and further preferably 14% or lower. While the lower limit is not particularly limited, the reduction ratio is preferably 4% or higher, more preferably 5% or higher, further preferably 6% or higher, and particularly preferably 7.5% or higher, from the viewpoint of bonding strength. According to surface-activated bonding, in particular, the upper limit can be 15%, and the lower limit can be 4%. Thus, properties of interest can be more stably attained. The reduction ratio of the roll-bonded laminate is determined based on the total thickness of the stainless steel plate material and the aluminum alloy plate material before bonding and thickness of the final form of the roll-bonded laminate. Specifically, the reduction ratio of the roll-bonded laminate can be determined in accordance with the formula: (total thickness of the stainless steel plate material and the aluminum alloy plate material before bonding—thickness of the final form of the roll-bonded laminate)/total thickness of the stainless steel plate material and the aluminum alloy plate material before bonding.

A line pressure load for roll bonding is not particularly limited. It may be determined to achieve a given reduction ratio of the aluminum alloy layer and that of the roll-bonded laminate. In the case of surface-activated bonding, for example, a line pressure load can be adjusted within a range of 1.6 tf/cm to 10.0 tf/cm. When a diameter of a pressure roll is 100 mm to 250 mm, for example, a line pressure load for roll bonding is preferably 1.9 tf/cm to 4.0 tf/cm, and more preferably 2.3 tf/cm to 3.0 tf/cm. When a roll diameter is increased or the stainless steel plate and the aluminum alloy plate are thick before bonding, however, it is occasionally necessary to increase a line pressure load to maintain a pressure that is necessary to achieve a given reduction ratio, and the line pressure load is not limited thereto.

At the time of bonding, temperature is not particularly limited. In the case of surface-activated bonding, for example, bonding is carried out at ordinary temperature to 150° C.

In the case of surface-activated bonding, bonding is preferably carried out in the non-oxidizing atmosphere, such as in an inert gas atmosphere (e.g., Ar), so as to prevent the bonding strength between the stainless steel plate and the aluminum alloy plate from lowering, which results from reabsorption of oxygen to the surface of the stainless steel plate and that of the aluminum alloy plate.

The roll-bonded laminate obtained by bonding the stainless steel plate to the aluminum alloy plate in the manner described above is subjected to thermal treatment. Thus, adhesion between layers can be improved to achieve the sufficient bonding force. Such thermal treatment can also serve as annealing of the roll-bonded laminate, in particular, the aluminum alloy layer.

In the case of batch thermal treatment, for example, thermal treatment temperature is 200° C. to 400° C., preferably 200° C. to 370° C., and more preferably 250° C. to 345° C. In the case of continuous thermal treatment, for example, it is 300° C. to 890° C., preferably 300° C. to 800° C., and more preferably 350° C. to 550° C. Such thermal treatment temperature is within a nonrecrystallized temperature range for stainless steel, and stainless steel is not substantially softened at such temperature. In the case of an aluminum alloy, work strain is eliminated, and an aluminum alloy is softened. The term “thermal treatment temperature” refers to a temperature of the roll-bonded laminate to be subjected to thermal treatment.

Through the thermal treatment, at least, metal elements contained in stainless steel (e.g., Fe, Cr, and Ni) are thermally diffused in the aluminum alloy layer. Alternatively, metal elements contained in stainless steel and aluminum may be thermally diffused alternately.

A duration of thermal treatment can be adequately determined in accordance with a thermal treatment method (batch or continuous thermal treatment), thermal treatment temperature, or a size of a roll-bonded laminate subjected to thermal treatment. In the case of batch thermal treatment, for example, temperature of the roll-bonded laminate is raised to a given level, and the roll-bonded laminate is then held at that temperature for 0.5 to 10 hours, and preferably for 2 to 8 hours. If an intermetallic compound is not generated, batch thermal treatment may be carried out for 10 hours or longer. In the case of continuous thermal treatment, temperature of the roll-bonded laminate is raised to a given level, and the roll-bonded laminate is then held at that temperature for 20 seconds to 5 minutes. The term “duration of thermal treatment” refers to a duration after the temperature of the roll-bonded laminate to be subjected to thermal treatment is raised to a given level, and such duration does not include a period during which temperature of the roll-bonded laminate is raised. A duration of thermal treatment may be approximately 1 to 2 hours when a material is as small as the A4 paper size in the case of batch thermal treatment. In the case of a large material, such as a long coil material with a width of 100 mm or larger and a length of 10 m or longer, batch thermal treatment needs to be carried out for approximately 2 to 8 hours.

An example of a means for regulating the surface hardness of the aluminum alloy layer of the roll-bonded laminate to satisfy the given correlation is a method in which a roll-bonded laminate with thickness of the aluminum alloy layer larger than the thickness of interest may be first prepared, the aluminum alloy layer of the roll-bonded laminate may be grounded to reduce thickness, and the laminate with thickness of interest may then be prepared. By grinding the aluminum alloy layer, the aluminum alloy layer can be hardened to improve the hardness. Alternatively, the roll-bonded laminate obtained as a result of bonding and thermal treatment may be subjected to configurational modification with the use of a tension leveler, so as to achieve elongation of approximately 1% to 2%. Thus, thickness can be reduced by approximately 1% to 2%, the aluminum alloy layer can be hardened, and surface hardness can be improved. Such means may be employed in adequate combination. For example, configurational modification may be carried out with the use of a tension leveler, and the aluminum alloy layer may then be grounded.

In order to enhance surface hardness of the stainless steel layer of the roll-bonded laminate to satisfy a given correlation, for example, original materials with high surface hardness may be prepared (hardness codes of H, ¾H, ½H, and BA in descending order of hardness), and these materials may be bonded to prepare a roll-bonded laminate. It should be noted that processing becomes difficult if surface hardness of a stainless steel layer is excessively high. Alternatively, a load may be increased at the time of bonding, so as to enhance surface hardness of the stainless steel layer of the roll-bonded laminate after bonding. For example, the layers may be bonded to each other so as to adjust the reduction ratio of the stainless steel layer to 0.5% to 10%. Thus, surface hardness of the stainless steel layer is increased from approximately 200 (Hv) to 270 (Hv).

Concerning the roll-bonded laminate produced in the manner described above, a framework may be formed via deep drawing using a press, and the exterior including the back surface may be subjected to surface treatment, such as grinding, chemical conversion, or coating. According to need, an inner surface may be cut or grounded to create concaves and convexes that are primarily necessary for incorporation of internal components. According to need, insert molding may be carried out with resin to form a metal-resin complex on inner and outer surfaces. In accordance with the method described above, the laminate can be processed into a housing, although the method is not limited thereto.

The resulting roll-bonded laminate has high rigidity and a high elastic modulus, and the configuration thereof can be satisfactorily retained. Thus, such laminate can be used for an electronic device housing, and, in particular, a housing for a mobile electronic device (e.g., a mobile terminal). It is preferable that the exterior of the housing using the roll-bonded laminate be made of a stainless steel layer, so that the appearance of the housing with a metallic luster can be obtained. The resulting housing may be subjected to treatment aimed at discoloration prevention or decoration. After the housing is prepared, the aluminum alloy material and the stainless steel material may be subjected to processing such as polishing or grinding, provided that the particular correlation according to the present invention is satisfied. The roll-bonded laminate can be preferably used as a component of an electronic device, such as an inner reinforcement member.

### EXAMPLES

Hereafter, the present invention is described in greater detail with reference to the examples and comparative examples, although the scope of the present invention is not limited to these examples.

### Example 1

The materials described below were provided as original plates, and roll-bonded laminates were produced via surface-activated bonding.

SUS304 BA (thickness 0.05 mm) was used as a stainless steel material, and A5052 H34 aluminum alloy (thickness 0.8 mm) was used as an aluminum material.

The surface of SUS304 and the surface of A5052 to be bonded to each other were subjected to sputter-etching. SUS304 was subjected to sputter-etching by introducing Ar as a sputtering gas at 0.3 Pa and a plasma output of 700 W for 12 minutes. A5052 was subjected to sputter-etching by introducing Ar as a sputtering gas at 0.3 Pa and a plasma output of 700 W for 12 minutes.

After the sputter-etching treatment, SUS304 was roll-bonded to A5052 with a roll diameter of 100 mm to 250 mm at ordinary temperature, a line pressure load of 0.5 tf/cm to 5.0 tf/cm, and a reduction ratio of the stainless steel layer of 0% to 5%. Thus, the roll-bonded laminate of SUS304 and A5052 was obtained. This roll-bonded laminate was subjected to batch thermal treatment at 320° C. for 1 hour. Thus, a roll-bonded laminate with the total thickness of 0.786 mm was produced.

### Example 2

A roll-bonded laminate with the total thickness of 0.799 mm was produced in the same manner as in Example 1, except for the use of SUS316L ½H (thickness 0.05 mm) as a stainless steel material.

### Example 3

A roll-bonded laminate with the total thickness of 0.848 mm was produced in the same manner as in Example 1, except for the use of SUS304 ½H (thickness 0.103 mm) as a stainless steel material.

### Example 4

A roll-bonded laminate with the total thickness of 0.798 mm was produced in the same manner as in Example 1, except for the use of SUS304 ½H (thickness 0.104 mm) as a stainless steel material.

### Example 5

A roll-bonded laminate with the total thickness of 0.907 mm was produced in the same manner as in Example 1, except for the use of SUS304 ½H (thickness 0.201 mm) as a stainless steel material.

### Example 6

The materials described below were provided as original plates, and roll-bonded laminates were produced via surface-activated bonding.

SUS304 BA (thickness 0.25 mm) was used as a stainless steel material, and A5052 H34 aluminum alloy (thickness 0.8 mm) was used as an aluminum material.

The surface of SUS304 and the surface of A5052 to be bonded to each other were subjected to sputter-etching. SUS304 was subjected to sputter-etching by introducing Ar as a sputtering gas at 0.1 Pa, a plasma output of 4800 W, and a line velocity of 4 m/min. A5052 was subjected to sputter-etching by introducing Ar as a sputtering gas at 0.1 Pa, a plasma output of 6400 W, and a line velocity of 4 m/min.

After the sputter-etching treatment, SUS304 was roll-bonded to A5052 at ordinary temperature and a line pressure load of 3.0 tf/cm to 6.0 tf/cm. Thus, the roll-bonded laminate of SUS304 and A5052 was obtained. This roll-bonded laminate was subjected to batch thermal treatment at 300° C. for 8 hours.

Subsequently, the roll-bonded laminate was subjected to configurational modification with the use of a tension leveler, so as to achieve elongation of approximately 1% to 2%. Thus, the total thickness of the roll-bonded laminate was reduced by approximately 1% to 2%, the aluminum alloy layer was hardened, and a roll-bonded laminate with the total thickness of 0.97 mm was produced.

### Example 7

A roll-bonded laminate with the total thickness of 1.025 mm was produced in the same manner as in Example 6, except for the use of SUS316L ½H (thickness 0.3 mm) as a stainless steel material and A5052 H34 (thickness 0.8 mm) as an aluminum alloy material.

### Example 8

A roll-bonded laminate with the total thickness of 0.574 mm was produced in the same manner as in Example 1, except for the use of SUS304 BA (thickness 0.3 mm) as a stainless steel material and A5052 H34 (thickness 0.3 mm) as an aluminum alloy material.

### Example 9

A roll-bonded laminate with the total thickness of 0.51 mm was produced in the same manner as in Example 6, except that SUS304 BA (thickness 0.15 mm) was used as a stainless steel material and A5052 H34 (thickness 0.5 mm) was used as an aluminum alloy material, the roll-bonded laminate was subjected to configurational modification with the use of a tension leveler, and the A5052 surface of the roll-bonded laminate was grounded to a given thickness with the use of emery paper.

### Example 10

A roll-bonded laminate with the total thickness of 0.59 mm was produced in the same manner as in Example 6, except for the use of SUS304 BA (thickness 0.15 mm) as a stainless steel material and A5052 H34 (thickness 0.5 mm) as an aluminum alloy material.

### Example 11

A roll-bonded laminate with the total thickness of 0.49 mm was produced in the same manner as in Example 9, except for the use of SUS304 BA (thickness 0.25 mm) as a stainless steel material and A5052 H34 (thickness 0.8 mm) as an aluminum alloy material.

### Example 12

A roll-bonded laminate with the total thickness of 0.58 mm was produced in the same manner as in Example 9, except for the use of SUS304 BA (thickness 0.25 mm) as a stainless steel material and A5052 H34 (thickness 0.8 mm) as an aluminum alloy material.

### Example 13

A roll-bonded laminate with the total thickness of 0.60 mm was produced in the same manner as in Example 6, except for the use of SUS316L BA (thickness 0.1 mm) as a stainless steel material and A5052 H34 (thickness 0.5 mm) as an aluminum alloy material.

### Example 14

A roll-bonded laminate with the total thickness of 0.952 mm was produced in the same manner as in Example 1, except for the use of SUS304 BA (thickness 0.2 mm) as a stainless steel material.

### Comparative Example 1

A roll-bonded laminate with the total thickness of 0.4 mm was produced in the same manner as in Example 1, except for the use of SUS304 BA (thickness 0.101 mm) as a stainless steel material and A5052 H34 (thickness 0.3 mm) as an aluminum alloy material.

### Comparative Example 2

A roll-bonded laminate with the total thickness of 0.28 mm was produced in the same manner as in Example 9, except for the use of SUS304 BA (thickness 0.15 mm) as a stainless steel material.

### Comparative Example 3

A roll-bonded laminate with the total thickness of 0.39 mm was produced in the same manner as in Example 9, except for the use of SUS304 BA (thickness 0.15 mm) as a stainless steel material.

### Comparative Example 4

A roll-bonded laminate with the total thickness of 0.29 mm was produced in the same manner as in Example 9, except for the use of SUS304 BA (thickness 0.25 mm) as a stainless steel material and A5052 H34 (thickness 0.8 mm) as an aluminum alloy material.

### Comparative Example 5

A roll-bonded laminate with the total thickness of 0.39 mm was produced in the same manner as in Example 9, except for the use of SUS304 BA (thickness 0.25 mm) as a stainless steel material and A5052 H34 (thickness 0.8 mm) as an aluminum alloy material.

The roll-bonded laminates produced in Examples 1 to 14 and Comparative Examples 1 to 5 were subjected to measurement of thickness and surface hardness of the stainless steel layers, those of the aluminum alloy layers, and thickness of the roll-bonded laminates. The load at 0.2% proof stress and the elastic modules were also determined.

Thickness of the Stainless Steel Layer and that of the Aluminum Alloy Layer

An optical microscopic photograph of a cross section of the roll-bonded laminate was obtained, thickness of the stainless steel layer or aluminum alloy layer at arbitrary 10 points in the optical microscopic photograph was measured, and the average thereof was determined.

### Thickness (Total Thickness) of the Roll-Bonded Laminate

Thickness of the roll-bonded laminate was determined by measuring thickness of the roll-bonded laminate at arbitrary 30 points thereon with the use of a micrometer or the like and calculating the average thereof.

### Surface Hardness of the Stainless Steel Layer

Surface hardness was determined using the Micro Vickers hardness tester (load: 200 gf) in accordance with JIS Z 2244 (Vickers hardness test—Test method).

### Surface Hardness of the Aluminum Alloy Layer

Surface hardness was determined using the Micro Vickers hardness tester (load: 50 gf) in accordance with JIS Z 2244 (Vickers hardness test—Test method).

### Load at 0.2% Proof Stress and Elastic Modulus

The load and the elastic modulus were determined in accordance with JIS K 7171 (Plastics—Determination of bending properties) and JIS Z 2241 (Metallic materials—Method of tensile testing). In this example, measurement was carried out from the stainless steel layer side of the roll-bonded laminate.

At the outset, a test piece of a width of 20 mm was prepared from the roll-bonded laminate, the test piece was subjected to the three-point bending test using a universal testing machine, TENSILON RTC-1350A (manufactured by Orientec Corporation), in accordance with JIS K 7171 (Plastics—Determination of bending properties) and JIS Z 2248 (Metallic materials—Method of bend testing) to obtain a chart showing a bending load and bending deflection (flexure). The three-point bending test was carried out with reference to FIG. 5 of JIS Z 2248 by designating the radius of the press tool as 5 mm, the support radius as 5 mm, and the support span as 40 mm.

With the use of the terms and the definitions used in JIS K 7171, bending stress σ was determined based on the bending load in accordance with the formula: bending stress σ=3FL/2bh² (wherein F represents a bending load, L represents a support span, b represents a test piece width, and h represents a test piece thickness (total thickness)). Also, bending strain E was determined based on the bending deflection in accordance with the formula: bending strain ε=600 sh/L² (wherein s represents bending deflection, h represents a test piece thickness (total thickness), and L represents a support span)).

In the chart demonstrating bending stress σ and bending strain ε (see FIG. 1), deflection in the bending stress in a region in which the bending strain ε is from 0.0005 to 0.0025 (0.05% to 0.25%) (slope: Δσ/Δε) was determined and designated as an elastic modulus. Bending stress at a point where a line moved from the line indicating the elastic modulus in parallel by +0.002 (+0.2%) in terms of the amount of strain is crossed with a curved line indicating bending stress (i.e., a line indicating “strain” in FIG. 1) was designated as 0.2% proof stress. A load F at 0.2% proof stress was determined in accordance with a 0.2% proof stress and the formula: bending stress σ=3 FL/2bh² (wherein F represents a bending load, L represents a support span, b represents a test piece width, and h represents a test piece thickness (total thickness)).

Table 1 shows the constitutions of the roll-bonded laminates of Examples 1 to 14 and Comparative Examples 1 to 5 and the results of evaluation thereof.

TABLE 1

| | | | | | SUS | Total | Load | | | |
|---|---|---|---|---|---|---|---|---|---|---|
| | | | | | thickness | thick- | at 0.2% | | | |
| | Stainless steel | | Aluminum alloy | | proportion | ness | proof | | | |
| | (SUS) layer | | (Al) layer | | T_{SUS}/ | T_{SUS} + | stress | | | Elastic |
| | Thickness | Hardness | Thickness | Hardness | (T_{SUS} + T_{Al}) | T_{Al} | (N/20 | | | modules |
| | T_{SUS}(mm) | H_{SUS} (HV) | T_{Al}(mm) | H_{Al}(HV) | (%) | (mm) | mm) | H_{SUS}T_{SUS}² | H_{Al}T_{Al}² | (Gpa) |
| Ex. 1 | 0.05 | 205.8 | 0.736 | 50 | 6.36 | 0.786 | 46.11 | 0.51 | 27.08 | 63.25 |
| Ex. 2 | 0.049 | 262.8 | 0.75 | 50 | 6.13 | 0.799 | 49.72 | 0.63 | 28.13 | 68.68 |
| Ex. 3 | 0.103 | 282.2 | 0.745 | 50 | 12.15 | 0.848 | 65.89 | 2.99 | 27.76 | 71.13 |
| Ex. 4 | 0.104 | 284.4 | 0.694 | 50 | 13.03 | 0.798 | 64.78 | 3.08 | 24.08 | 84.58 |
| Ex. 5 | 0.201 | 322 | 0.706 | 50 | 22.16 | 0.907 | 80.41 | 13.01 | 24.92 | 74.66 |
| Ex. 6 | 0.24 | 280 | 0.73 | 58 | 24.74 | 0.97 | 95.54 | 16.13 | 30.91 | 83.09 |
| Ex. 7 | 0.291 | 335 | 0.734 | 65 | 28.39 | 1.025 | 123.2 | 28.37 | 35.02 | 82.90 |
| Ex. 8 | 0.297 | 237.4 | 0.277 | 48.6 | 51.74 | 0.574 | 37.68 | 20.94 | 3.73 | 89.46 |
| Ex. 9 | 0.15 | 280 | 0.36 | 75 | 29.41 | 0.51 | 39.23 | 6.3 | 9.72 | 77.08 |
| Ex. 10 | 0.16 | 280 | 0.44 | 75 | 25.42 | 0.59 | 49.48 | 6.3 | 14.52 | 101.75 |
| Ex. 11 | 0.24 | 280 | 0.25 | 75 | 48.98 | 0.49 | 39.14 | 16.13 | 4.69 | 94.36 |
| Ex. 12 | 0.24 | 280 | 0.34 | 75 | 41.38 | 0.58 | 49.22 | 16.13 | 8.67 | 93.39 |
| Ex. 13 | 0.1 | 230.2 | 0.5 | 64.08 | 16.67 | 0.6 | 49.69 | 2.30 | 16.02 | 106.83 |
| Ex. 14 | 0.2 | 222.6 | 0.752 | 52.8 | 21.01 | 0.952 | 87.43 | 8.90 | 29.86 | 75.72 |
| Ex. 15 | 0.21 | 277.3 | 0.34 | 73.3 | 38.18 | 0.55 | 37.57 | 12.23 | 8.47 | 85.10 |
| Comp. Ex. 1 | 0.101 | 206 | 0.299 | 50.98 | 25.25 | 0.4 | 17.45 | 2.09 | 4.56 | 103.07 |
| Comp. Ex. 2 | 0.15 | 280 | 0.13 | 75 | 53.57 | 0.28 | 13.25 | 6.3 | 1.27 | 95.09 |
| Comp. Ex. 3 | 0.15 | 280 | 0.24 | 75 | 38.46 | 0.39 | 24.59 | 6.3 | 4.32 | 83.74 |
| Comp. Ex. 4 | 0.24 | 280 | 0.05 | 75 | 82.76 | 0.29 | 22.26 | 16.13 | 0.19 | 150.58 |
| Comp. Ex. 5 | 0.24 | 280 | 0.15 | 75 | 61.54 | 0.39 | 29.95 | 16.13 | 1.69 | 118.38 |

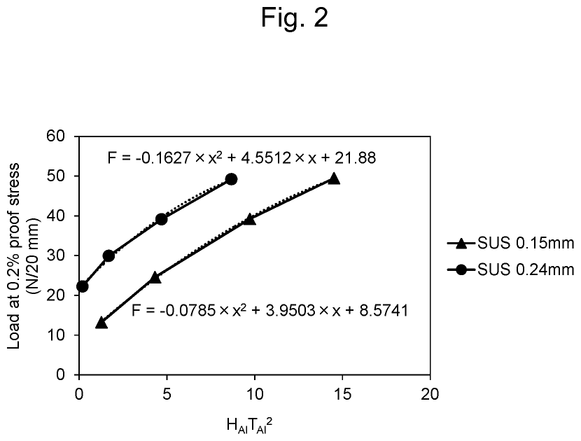

It is considered that thickness and surface hardness of the stainless steel layer and the aluminum alloy layer influence rigidity of the roll-bonded laminate. Based on the correlation in FIG. 2, which is described below, the load F at 0.2% proof stress is represented by Formula (3): F=(a×z+b)×x²+(c×z+d)×x+e×z+f (wherein x represents surface hardness H_{Al} (HV)×(thickness T_{Al} (mm))² of the aluminum alloy layer, and z represents surface hardness H_{SUS} (HV)×(thickness T_{SUS} (mm))² of the stainless steel layer). Concerning two conditions in which surface hardness and thickness of the stainless steel layer are constant, the correlation indicating H_{Al}T_{Al}² and the load F at 0.2% proof stress was determined. FIG. 2 shows the correlation between H_{Al}T_{Al}² and the load at 0.2% proof stress under two conditions in which surface hardness H_{SUS} and thickness T_{SUS} of the stainless steel layer are constant. When H_{SUS} is 280 HV and T_{SUS} is 0.15 mm (Examples 9 and 10 and Comparative Examples 2 and 3), as shown in FIG. 2, H_{Al}T_{Al}² and the load F are represented by Formula (5): F=−0.0785×x²+3.9503×x+8.5741. When H_{SUS} is 280 HV and T_{SUS} is 0.24 mm (Examples 11 and 12 and Comparative Examples 4 and 5), H_{Al}T_{Al}² and the load F are represented by Formula (6): F=−0.1627×x²+4.5512×x+21.88. With the use of Formulae (5) and (6), a, b, c, d, e, and f in Formula (3) were determined, and the load F at 0.2% proof stress represented by Formula (3) was obtained.

F=(−0.008×H_{SUS}T_{SUS}²−0.03)×(H_{Al}T_{Al}²)²+(0.061×H_{SUS}T_{SUS}²+3.57)×H_{Al}T_{Al}²+1.354×H_{SUS}T_{SUS}²+0.04: Formula (3)

In order to bring the load F at 0.2% proof stress to 35 N/20 mm or higher required for the housing in accordance with Formula (3), the roll-bonded laminate may satisfy the correlation represented by Formula (1): H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354). In order bring the load F at 0.2% proof stress to 45 N/20 mm or higher, the roll-bonded laminate may satisfy the correlation represented by Formula (2): H_{SUS}T_{SUS}²≥(44.96+0.03×(H_{Al}T_{Al}²)²−3.57×H_{Al}T_{Al}²)/(−0.008×(H_{Al}T_{Al}²)²+0.061×H_{Al}T_{Al}²+1.354).

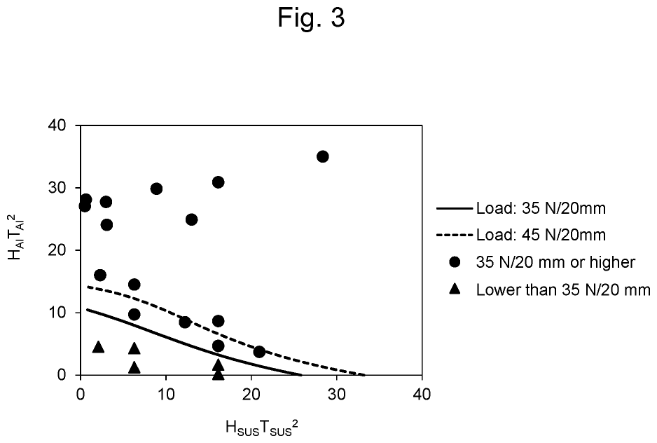

FIG. 3 shows the correlation between surface hardness H_{SUS}×thickness T_{SUS}² of the stainless steel layer and surface hardness H_{Al}×thickness T_{Al}² of the aluminum alloy layer of the roll-bonded laminates of Examples 1 to 14 and Comparative Examples 1 to 5. In FIG. 3, a solid line indicating “Load: 35 N/20 mm” represents a correlation when a load at 0.2% proof stress is 35 N/20 mm in Formula (1), a broken line indicating “Load: 45 N/20 mm” represents a correlation when a load at 0.2% proof stress is 45 N/20 mm in Formula (2). Table 1 and FIG. 3 demonstrate that the roll-bonded laminates of Examples 1 to 14 exhibiting thickness T_{Al} (mm) and surface hardness H_{Al} (HV) of the aluminum alloy layer and thickness T_{SUS} (mm) and surface hardness H_{SUS} (HV) of the stainless steel layer that satisfy the correlation represented by Formula (1) exhibit a high load of 35 N/20 mm or higher at 0.2% proof stress and high rigidity. In addition, the roll-bonded laminates of Examples 1 to 7, 10, and 12 to 14 exhibiting thickness T_{Al} (mm) and surface hardness H_{Al} (HV) of the aluminum alloy layer and thickness T_{SUS} (mm) and surface hardness H_{SUS} (HV) of the stainless steel layer that satisfy the correlation represented by Formula (2) exhibit a particularly high load of 45 N/20 mm or higher at 0.2% proof stress and higher rigidity. In contrast, the roll-bonded laminates of Comparative Examples 1 to 5 that do not satisfy the correlation represented by Formula (1) exhibit a load of less than 35 N/20 mm at 0.2% proof stress. That is, such laminates are insufficient as the roll-bonded laminates for housing applications. In addition, roll-bonded laminates exhibiting a high elastic modulus of 70 GPa or higher in addition to high rigidity were obtained (comparison of Examples 1 and 2 with Examples 3 to 14) by satisfying the correlation represented by Formula (1) and adjusting the thickness proportion of the stainless steel layer to 10% or higher.

### Example 15

An electronic device housing was prepared by molding a roll-bonded laminate composed of a stainless steel layer and an aluminum alloy layer. At the outset, materials described below were provided as original plates, and a roll-bonded laminate was produced via surface-activated bonding.

SUS304 BA (thickness 0.25 mm) was used as a stainless steel material, and A5052 H34 aluminum alloy (thickness 0.8 mm) was used as an aluminum alloy material.

The surface of SUS304 and the surface of A5052 to be bonded to each other were subjected to sputter-etching. SUS304 was subjected to sputter-etching by introducing Ar as a sputtering gas at 0.1 Pa, a plasma output of 4800 W, and a line velocity of 4 m/min. A5052 was subjected to sputter-etching by introducing Ar as a sputtering gas at 0.1 Pa, a plasma output of 6400 W, and a line velocity of 4 m/min.

After the sputter-etching treatment, SUS304 was roll-bonded to A5052 at ordinary temperature and a line pressure load of 3.0 tf/cm to 6.0 tf/cm. Thus, the roll-bonded laminate of SUS304 and A5052 was obtained. This roll-bonded laminate was subjected to batch thermal treatment at 320° C. for 8 hours.

Subsequently, the roll-bonded laminate was subjected to configurational modification with the use of a tension leveler, so as to achieve elongation of approximately 1% to 2%. Thus, the total thickness of the roll-bonded laminate was reduced by approximately 1% to 2%, the aluminum alloy layer was hardened, and a roll-bonded laminate with the total thickness of 0.97 mm was produced.

Subsequently, the resulting roll-bonded laminate was subjected to deep drawing in a size of 150 mm (lengthwise)×75 mm (transverse) to a depth of 10 mm. Subsequently, the stainless steel layer was polished, the aluminum alloy layer was grounded, and the housing with the total thickness of 0.551 mm serving as the back surface of the electronic device was produced.

### Measurement of Thickness and Other Properties of the Stainless Steel Layer and the Aluminum Alloy Layer

A central region of 20 mm×50 mm was cut from the housing back surface, and thickness of the stainless steel layer, thickness of the aluminum alloy layer, surface hardness of the stainless steel layer, surface hardness of the aluminum alloy layer, and the load at 0.2% proof stress and the elastic modulus were measured in the same manner as in the method for measuring the roll-bonded laminate composed of the stainless steel layer and the aluminum alloy layer. The results are shown in Table 1 and FIG. 3.

### Results of Evaluation

As shown in Table 1 and FIG. 3, the electronic device housing of Example 15 obtained by molding a roll-bonded laminate composed of a stainless steel layer and an aluminum alloy layer also satisfied the correlation represented by Formula (1) as with the roll-bonded laminates of the examples, and it exhibited a load as high as 35 N/20 mm or higher at 0.2% proof stress and high rigidity. In addition, the electronic device housing of Example 15 exhibited an elastic modulus as high as 70 GPa or higher. When the material with the load at 0.2% proof stress and the elastic modulus as mentioned above is used as a back surface of the electronic device housing, components inside the housing would not be adversely affected. Thus, thickness of the entire electronic device can be reduced, the battery capacity can be increased, and the inner capacity can be increased.

The roll-bonded laminates of Reference Examples 1 to 7 were produced and evaluated in terms of the properties described below.

### Reference Example 1

SUS304 (thickness 0.2 mm) was used as a stainless steel material, and A5052 aluminum alloy (thickness 0.8 mm) was used as an aluminum material. SUS304 and A5052 were subjected to sputter-etching. SUS304 was subjected to sputter-etching at 0.1 Pa and a plasma output of 700 W for 13 minutes, and A5052 was subjected to sputter-etching at 0.1 Pa and a plasma output of 700 W for 13 minutes. After the sputter-etching treatment, SUS304 was roll-bonded to A5052 with a roll diameter of 130 mm to 180 mm at ordinary temperature and a line pressure load of 1.9 tf/cm to 4.0 tf/cm. Thus, the roll-bonded laminate of SUS304 and A5052 was obtained. This roll-bonded laminate was subjected to batch annealing at 300° C. for 2 hours. Concerning the roll-bonded laminate after annealing, the reduction ratio of the stainless steel layer, that of the aluminum alloy layer, and that of the entire roll-bonded laminate were determined based on the thickness of the original plates before bonding and the thickness of the final form of the roll-bonded laminate.

### Reference Examples 2 to 4, 6, and 7

The roll-bonded laminates of Reference Examples 2 to 4, 6, and 7 were obtained in the same manner as in Reference Example 1, except that thickness of the of the original aluminum plate, the reduction ratio at the time of bonding by changing the pressure, and/or the annealing temperature were changed to given levels. In Reference Example 2, the roll-bonded laminate produced in Example 5 was cut and subjected to evaluation, and a slight difference was observed in thickness of the roll-bonded laminate.

### Reference Example 5

The roll-bonded laminate produced in Example 6 was cut and subjected to evaluation.

Concerning the roll-bonded laminates of Reference Examples 1 to 7, the 180° peel strength of the roll-bonded laminates after bonding and before annealing and that of the final form of the roll-bonded laminates after annealing were measured. Concerning the roll-bonded laminates of Reference Examples 1 to 7, in addition, tensile strength and elongation were measured, and bending workability and drawing workability were evaluated. Measurement of 180° peel strength, tensile strength, and elongation and evaluation of bending workability and drawing workability were carried out in the manner described below.

### 180° Peel Strength

A test piece with a width of 20 mm was prepared from the roll-bonded laminate, the stainless steel layer was partly peeled from the aluminum layer, the aluminum layer side was fixed, the stainless steel layer was pulled toward the direction opposite by 180° from the aluminum layer side at a tension rate of 50 mm/min, and a force required to peel the stainless steel layer from the aluminum layer (unit: N/20 mm) was measured using a universal testing machine, TENSILON RTC-1350A (manufactured by Orientec Corporation).

### Tensile Strength

Tensile strength was measured with the use of a universal testing machine, TENSILON RTC-1350A (manufactured by Orientec Corporation), and Special Test Piece No. 6 specified by JIS Z 2201 in accordance with JIS Z 2241 (Metallic materials—Method of tensile testing).

### Elongation

With the use of the test piece for the tensile test, elongation was measured in accordance with the method of measurement of elongation at break specified by JIS Z 2241.

### Bending Workability

A test piece was bent by a V-block method (a bending angle of 60°; processed with a pressing tool with R of 0.5, a load of 1 kN; test material width of 10 mm; JIS Z 2248).

### Drawing Workability

With the use of the mechanical Erichsen testing machine (a universal sheet metal testing machine; model: 145-60; Erichsen), cylindrical drawing was performed and evaluated. Drawing conditions were as follows.

Blank diameter (ϕ): 49 mm (drawing ratio: 1.63) or 55 mm (drawing ratio: 1.83)
Punch size (ϕ): 30 mm
Punch shoulder (R): 3.0
Die shoulder (R): 3.0
Wrinkle suppression pressure: 3 N

### Lubricant oil: Press oil (No. 640, Nihon Kohsakuyu Co., Ltd.)

Mold temperature: room temperature (25° C.)
Mold velocity: 50 mm/sec

Drawing workability was evaluated according to a 5-point scale shown in Table 2 below. A higher numerical value indicates higher drawing workability. With a blank diameter of 55 mm (drawing ratio of 1.83), drawing work is more difficult compared with the case with a blank diameter of 49 mm (drawing ratio of 1.63).

TABLE 2

| φ | Drawing ratio | 1 | 2 | 3 | 4 | 5 |
|---|---|---|---|---|---|---|
| 49 | 1.63 | Poor | Good | Good | Good | Excellent |
| 55 | 1.83 | Poor | Fair | Average | Good | Excellent |

Poor: Undrawable;
Fair: Drawable with cracks;
Average: Drawable with some wrinkles;
Good: Drawable;
Excellent: Drawable with good appearance

Table 3 shows constitutions, production conditions, and the results of evaluation of the roll-bonded laminates of Reference Examples 1 to 7.

| | | | | | | | Peel | | Peel | | | | |
|---|---|---|---|---|---|---|---|---|---|---|---|---|---|
| | Original plate | | | | | | strength | | strength | | | | |
| | thickness (mm) | | | Reduction ratio (%) | | | after | Annealing | after | | | | Tensile |
| | | | Total | | | Entire | bonding | temperature | annealing | Bending | Drawing | Elongation | strength |
| | SUS | Al | thickness | SUS | Al | laminate | (N/20 mm) | (° C.) | (N/20 mm) | workability | workability | (&) | (N) |
| Ref. Ex. 1 | 0.2 | 0.8 | 1 | 2.5 | 6.38 | 5.60 | 10 or lower | 300 | 74.5 | Good | 3 | 55 | 4560 |
| Ref. Ex. 2 | 0.2 | 0.8 | 1 | 7 | 9.38 | 8.90 | 10 or lower | 300 | 88 | Good | 4 | 60 | 4561 |
| Ref. Ex. 3 | 0.2 | 0.8 | 1 | 7 | 9.38 | 8.90 | 10 or lower | 350 | 136 | Good | 5 | 51.5 | 4570 |
| Ref. Ex. 4 | 0.2 | 0.4 | 0.6 | 4 | 6.76 | 5.83 | 10 or lower | 300 | 162 | Good | 5 | 49 | 3520 |
| Ref. Ex. 5 | 0.25 | 0.8 | 1.06 | 4 | 8.75 | 7.61 | 10 or lower | 300 | 120 | Good | 5 | 45 | — |
| Ref. Ex. 6 | 0.2 | 0.8 | 1 | 1.5 | 4.88 | 4.20 | 10 or lower | 300 | 34 | Good | 1 | 54 | 4744 |
| Ref. Ex. 7 | 0.2 | 0.8 | 1 | 7 | 9.38 | 8.90 | 10 or lower | 400 | 4 | Poor | — | 61.5 | 4559 |

Table 3 demonstrates that, compared with the roll-bonded laminate of Reference Example 6 in which the reduction ratio of the aluminum alloy layer was lower than 5%, the roll-bonded laminates of Reference Examples 1 and 2 produced by increasing the pressure at the time of bonding to increase the reduction ratio of the aluminum alloy layer exhibited an equivalent peel strength after bonding and before annealing and a significantly improved peel strength and enhanced drawing workability after annealing. According to Reference Examples 2, 3, and 7, in addition, the peel strength of the roll-bonded laminate after annealing was enhanced at an adequate annealing temperature. In the case of batch annealing, an adequate temperature range may be from 200° C. to 370° C. When an aluminum material is thin, the peel strength of the roll-bonded laminate could also be enhanced. In such a case, in particular, a range of improvement in the peel strength before annealing to after annealing was significant (Reference Example 4).

### REFERENCE SIGNS LIST

4: Electronic device housing
40: Back surface
41: Side surface
A: Plane region

All publications, patents, and patent applications cited herein are incorporated herein by reference in their entirety.

1. A roll-bonded laminate for an electronic device composed of a stainless steel layer and an aluminum alloy layer, wherein thickness T_{Al} (mm) and surface hardness H_{Al} (HV) of the aluminum alloy layer and thickness T_{SUS} (mm) and surface hardness H_{SUS} (HV) of the stainless steel layer satisfy the correlation represented by Formula (1) below.
H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (1)

2. The roll-bonded laminate for an electronic device according to claim 1, which satisfy the correlation represented by Formula (2) below.
H_{SUS}T_{SUS}²≥(44.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (2)

3. The roll-bonded laminate for an electronic device according to claim 1, wherein the proportion of thickness T_{SUS} of the stainless steel layer to the total thickness of the roll-bonded laminate is 10% to 85%.

4. An electronic device housing mainly composed of a metal comprising a roll-bonded laminate composed of a stainless steel layer and an aluminum alloy layer on its back surface and/or side surface, wherein thickness T_{Al} (mm) and surface hardness H_{Al} (HV) of the aluminum alloy layer and thickness T_{SUS} (mm) and surface hardness H_{SUS} (HV) of the stainless steel layer satisfy the correlation represented by Formula (1) below.
H_{SUS}T_{SUS}²≥(34.96+0.03×(H_{Al}T_{Al}²)²−3.57×H_{Al}T_{Al}²)/(−0.008×(H_{Al}T_{Al}²)²+0.061×H_{Al}T_{Al}²+1.354): Formula (1)

5. The electronic device housing according to claim 4, which satisfies the correlation represented by Formula (2) below.
H_{SUS}T_{SUS}²≥(44.96+0.03×(H_{Al}T_{Al}²)²−3.57×H_{Al}T_{Al}²)/(−0.008×(H_{Al}TA)²+0.061×H_{Al}T_{Al}²+1.354): Formula (2)

6. The electronic device housing according to claim 4, wherein the proportion of thickness T_{SUS} of the stainless steel layer to the total thickness of the electronic device housing is 10% to 85%.
